(19) United States
(12) Patent Application Publication
(10) Pub. No.: US 2004/0077975 A1
(43) Pub. Date: Apr. 22, 2004

(54) Systems and methods for motion analysis and feedback

(76) Inventor: Jeffrey C. Zimmerman, Westport, CT (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 10/358,396

(22) Filed: Feb. 5, 2003

Related U.S. Application Data
(60) Provisional application No. 60/419,997, filed on Oct. 22, 2002.

(51) Int. Cl. G01C 9/00

(52) U.S. Cl. 600/595

(57) ABSTRACT

The invention relates to motion analysis systems, methods, and programs for analyzing the motions or positions of humans and providing feedback thereon so that the users may improve their movements or postures. The analysis is in terms of the positions and motions of sensors that are carefully placed at vital energy points along the body, especially acupuncture points and chakras. The systems, methods, and programs allow users to master techniques that improve their vital energy flow, thus providing higher energy levels. In one aspect, the sensors are placed anywhere on the body, and tactile feedback devices provide tactile feedback to indicate errant motions.

### CROSS REFERENCE TO RELATED APPLICATION

This application claims priority to U.S. Provisional Patent Application Serial No. 60/419,997, filed Oct. 22, 2002.

### FIELD OF THE INVENTION

This invention relates to systems, methods, and computer programs of a person's motion and for providing feedback to allow the person to correct errant movements. More particularly, the invention relates to systems, methods, and software wherein a computer or an electronically programmed receiver analyzes the movements of specific energy points and provides immediate feedback in a user-selected graphical environment, to allow persons analyzed to correct their movements in a way that improves energy flow.

### BACKGROUND OF THE INVENTION

Empirical sciences, such as Oriental and Ayurvedic Medicines including acupuncture and acupressure are ancient healing arts that have been well studied and documented throughout the ages. The theoretical basis for these arts is that human bodies contain a system of channels (also known as meridians or pathways) through which energy (qi) flows. Channels connect a body's organs, tissues, and nerves; these channels are each associated with physiological systems and internal organs. Three hundred sixty one acupuncture points have been identified along the main channels, and a multitude of other (“extraordinary”) points have also been identified. The acupuncture points along each defined channel have a known effect on the systems and organs associated with that channel. Within the ancient healing arts, the methods of treating ailments and promoting physical well-being are well known, as are the locations of the acupuncture points on the body. Examples of references in which the locations of acupuncture points on the body and their significance are described include Essentials of Chinese Acupuncture, compiled by the Beijing College of Traditional Chinese Medicine (Foreign Language Press, 1993), Chen Xinnong (ed.), Chinese Acupuncture and Moxibustion (Revised Edition) (China Books & Periodicals, 2000), and Andy Ellis, Fundamentals of Chinese Medicine (Paradigm Publications, 1997); each of these is incorporated herein by reference. The locations of acupuncture points on the body are even available on the World Wide Web through an interactive acupuncture chart at http://www.qi-journal.com/tcmarticles/acumodel/AcuModel.asp.

There are many methods and techniques known in the oriental healing arts such as acupuncture and acupressure to improve energy levels and general health and well-being. Many oriental medical, physical, and meditation practices teach that important physical locations such as acupuncture points, located throughout the body, are essential to establishing and maintaining vital energy, as described in Kiiko Matsumoto et al., Five Elements and Ten Stems: Nan Ching Theory, Diagnostics and Practice (Paradigm Publications, 1983) and Shou-Yu Liang et al., Qigong Empowerment: A Guide to Medical, Taoist, Buddhist, Wushu Energy Cultivation (Way of the Dragon, 1996); both incorporated herein by reference. Furthermore, in addition to the importance of the manipulation of acupuncture points to physical health and well-being, Oriental and Ayurvedic Medicine also have recognized the involvement of energy centers, or chakras, within the body for physical and psychological well-being. The locations of the chakras and their manipulation for physical and spiritual well-being is described in Rosalyn L. Bruyere, Wheels of Light: Chakras, Auras, and the Healing Energy of the Body (Fireside, 1994), incorporated herein by reference.

Many techniques for improvement of physical and psychological well-being focus on precise movement. There are numerous references on the practice of these techniques, including yoga, tai chi, qigong, and various forms of martial art techniques. (See, for example, Shou-Yu Liang et al., Baguazhang (Emei Baguazhang: Theory and Applications) (Ymaa Publications, 1994), Shou-Yu Liang et al., Tai Chi Chuan: 24 and 48 Postures With Martial Applications (Ymaa Publications, 1996), and Bruce Lee, Tao of Jeet Kune Do (Library of Congress 75-24803); each incorporated herein by reference.) However, in order for these techniques to be effective, it is important that they be performed correctly. Especially important is that the body's “vital energy points,” acupuncture points and chakras, are aligned and move correctly according to ancient teachings of the Oriental and Ayurvedic healing arts. Heretofore, a student of these disciplines would have to rely on a human instructor, who would observe the student's movements and body positions, then provide critiques thereon. This is often inconvenient for the student, who must schedule time to practice with a personal instructor. There is a need for time and cost effective systems and methods by which students of oriental posture, meditation, and movement disciplines can learn the correct positions and movements of energy points without relying on a paid personal instructor.

Correct alignment and movement of the vital energy points is well known in the oriental healing and martial arts to be important to physical health and well-being. Even every day movements and postures such as walking, running, standing, sitting, and lying down should be performed in particular ways in order to ensure proper movement and alignment of the vital energy points. Often such important every day movements and postures are taken for granted or completely ignored. Furthermore, everyone participating in a sport can benefit from proper movement and alignment of the vital energy points, the benefits being an overall increase in energy levels, avoidance of injury, and even healing of past injuries. Hence, there is a need for a system, method, and program that can provide feedback to people to help train them how to perform everyday activities and favorite sporting activities in a manner that allows the correct alignment and movement of their vital energy points.

There are several systems, methods, and programs for providing automated analysis of human motions for instructional purposes, for example the analysis of golf swings. Specifically, U.S. Pat. No. 5,111,410, incorporated herein by reference, discusses a motion diagnosis system that picks up motions of a human subject and analyzes them by extracting data representing features of the motion, and comparing that data with reference data. The system gives feedback to the subject in the form of a spoken critique of the subject's performance after the subject has completed the analyzed motion. However, this system does not provide real time instantaneous feedback during the subject's motion, other than a visual representation of the subject's motion, without any indication of how that motion should be improved. U.S. Pat. No. 5,826,578, incorporated by reference, discusses a motion analysis system that allows real time or delayed observation while performing a motion. This system allows the graphical display of a moving image of the subject body compared with sample movement of a reference body, such as a professional who performs the motion in an ideal manner. However, neither of these systems, nor any system in the prior art, monitors the synchronized motion or position of vital energy points.

### SUMMARY OF THE INVENTION

The invention provides systems, methods, and programs for automated detection of human postures and movements, analysis and evaluation of the same by comparison to established standards, and correction of the same by providing instantaneous feedback. In one aspect, the invention includes systems and methods for measuring the position and movement of a human's vital energy points. As used herein, the term “vital energy points” refers to acupuncture points, meridians, and meridian endpoints, positioned as described in Essentials of Chinese Acupuncture, compiled by the Beijing College of Traditional Chinese Medicine (Foreign Language Press, 1993), Chen Xinnong (ed.), Chinese Acupuncture and Moxibustion (Revised Edition) (China Books & Periodicals, 2000), Royston Low, The Secondary Vessels of Acupuncture, (Thorsons Publishing Group, 1983), and Andy Ellis, Fundamentals of Chinese Medicine (Paradigm Publications, 1997), and the chakras, positioned as described in Rosalyn L. Bruyere, Wheels of Light: Chakras, Auras, and the Healing Energy of the Body (Fireside, 1994). All of these books are incorporated herein by reference in their entireties. The term “vital energy points” may also refer to networks throughout the body through which energy flows. The energy includes energy of the joints, tendons, and muscles, and includes the six levels of energy known in the art as tai yang, shao yang, yang ming, tai yin, shao yin, and jueyin. The networks includes the eight extraordinary vessels known as du mai (the governing vessel), ren mai (the conception vessel), yin chiao mai, yang chiao mai, yin wei mai, yang wei mai, dai mai, and chong mai. The energies that flow through the vital energy points include the energies known as the five elements (earth, water, metal, fire, and wood), and the bagua of energy (defined as fire, earth, heaven, lake, water, mountain, thunder, and wind).

In a broader aspect, the invention includes placing sensors on acupuncture points, along meridians, on chakras, or on tendons, muscles, and body parts associated with energy. In another aspect, the invention includes systems, methods, and programs for providing real time feedback to a person who is learning a movement or posture technique in a user-selected graphical environment.

In one aspect, the invention includes a method for analyzing postures or movements of a human subject by placing one or more sensors on one or more vital energy points throughout the human subject's body. The sensors may be placed in an extended manner along meridians, at the endpoints of meridians, on chakras, or they may be placed at any other vital energy point known to those skilled in the art of energy medicines, such as oriental and Ayurvedic medicine. The positions of the sensors are detected by any suitable detection means, including detections of signals sent by the sensor indicating their positions or video detection of the sensors followed by image analysis to determine the positions of the sensors, or by other motion capture technologies known to those skilled in that art.

The positions of the one or more sensors as detected are compared to a predetermined set of positions of one or more corresponding vital energy points. The predetermined set of positions of vital energy points can be made by an expert who has assumed the postures or made the movements that the subject is practicing, or preprogrammed by an expert who knows how the various vital energy points should be positioned or moved. A visual, auditory, tactile or any combination of signals thereof (signal) is provided to indicate whether the positions of the one or more sensors on the subject match the predetermined set of positions of one or more vital energy points.

The method may be used to analyze yoga postures, martial arts movements, or any other posture or movement, including ordindinary, every day activities. The method may also include displaying a graphically representation of the human subject that moves in the same way the human subject moves. The method may further include displaying the graphical representation of the human subject in an environment selected by the human subject. The method may further include displaying a graphical representation of a reference body, where the postures and motions of the reference body may represent the postures adopted by and the motions made by the expert. The method may further include providing any number of environmentally pleasing effects, including providing relaxing sounds such as classical music, or relaxing scents, such as aromatherapy.

In another aspect, the invention includes a system for analyzing postures or movements of a human subject. The system may include a plurality of sensors placed on vital energy points throughout the human subject's body, including on acupuncture points, along meridians, on the endpoints of meridians, and/or on chakras.

The system may include a detector for detecting the positions of the sensors. The detector may be a receiver for receiving signals transmitted from the sensors indicating their location, or it may be a video camera in combination with computer vision software for determining the positions of the sensors, or it may be any other detection means known to those skilled in the art of position sensing.

The system may further include an electronic analysis device such as a computer, Palm Pilot, Game Boy, or DVD, for receiving data from the detector, wherein the data indicates the positions of the sensors. The computer or other electronic analysis device may compare the positions of the sensors with a predetermined reference set of positions of vital energy points to determine whether the positions of the sensors match the predetermined set of positions of vital energy points. As used herein, the term “match” means that the positions of the sensors should fall within some predetermined range of positions in the vicinity of the positions as determined by the reference positions. If the sensor positions match the predetermined set of positions of vital energy points, then the sensors are in the conforming regions because they conform to the positions dictated by the predetermined set of positions. The positions of the sensors need not be precisely the same as the predetermined reference positions in order to match. In one aspect, the invention may provide an access through a communications network to a database of predetermined sets of positions of vital energy points that can be downloaded to a user's location and used with the user's system.

The system may further include a television screen, computer monitor, or other visual display device including hand-held devices, and/or a speaker or headset. The computer or other electronic analysis device may display a visual signal and/or an auditory signal and/or a tactile signal to indicate whether the positions of the sensors match the predetermined reference positions of vital energy points. The system may display a graphical representation of the human subject on the visual display device, where the graphical representation moves in the same way that the human subject moves or some other visual feedback may be provided. In one embodiment, the graphical representation of the human subject is depicted in an environment that has been selected by the human subject. In another embodiment, the graphical representation of the human subject and/or the reference body depicts the predetermined set of vital energy points.

The systems, methods, and programs of the invention may be used in many different contexts to provide numerous different beneficial results. For example, the invention may provide users with training that can increase their natural energy flow. The invention may provide users with training that can increase the users' efficiency in performing any number of activities. The invention may be used in a medical setting, for example, as physical therapy treatment to strengthen joints, muscles, or tendons or to offset over-compensation due to existing injuries or weaknesses. The invention may be useful in training for all types of sports, for personal fitness, weightlifting, to train in proper walking, running, or stretching techniques, in martial arts such as those forms listed on the World Wide Web site of: www.martialinfo.com, dancing, yoga, tai chi, chi gong, or aerobics, for example. Each of these different activities may emphasize different vital energy points.

In one aspect of the invention, feedback is provided through a tactile signal. This aspect of the invention may be used independently of or in combination with the aspect of the invention wherein sensors are placed on vital energy points. In this aspect of the invention, devices for providing tactile signals can be attached at various points throughout a subject's body, along with the position sensors as described above. In one embodiment, the devices for providing tactile signals can be part of the sensors. When the system senses that one or more sensors have left the conforming region, the one or more devices for providing tactile signals may be triggered, thus providing a tactile signal to the subject that the subject has made an errant movement.

### DESCRIPTION OF THE FIGURE

FIG. 1 is a flow diagram of the method of one embodiment of the invention.

### DETAILED DESCRIPTION OF THE INVENTION

The present invention includes systems, methods, and programs for analyzing postures and movements of human subjects by detecting the locations and movements of various points throughout the body. The invention may provide instantaneous feedback allowing the subjects to improve the efficiency of their movements. In one aspect, the invention includes placing sensors at key energy points throughout the body, including, but not limited to acupuncture points, at the endpoints of meridians, extended along meridians, on chakras, and on tendons, muscles, and body parts associated with vital energy. The sensors may be monitored by a video motion analysis system such as that discussed in U.S. Pat. No. 5,072,294, incorporated herein by reference. Alternatively, the sensors may transmit position information directly, such as those discussed in U.S. Pat. No. 5,907,819, incorporated herein by reference. Alternatively, any electronic motion analysis system or receiver may monitor sensors.

The sensors may be motion and/or position sensors that transmit information to receivers. The sensors may transmit such information as the distance between sensors, the speed of the sensors, the direction of motion of the sensors, the absolute positions of the sensors, or any combination thereof. Receivers may receive this information from the sensors, and may send this information to a computer. The sensors may be light reflectors, emitters, or other objects known to those skilled in the art to provide good signals for video, audio, and/or tactile. The receiver may then be a video camera or other electronic screen directed at the subject. A video feed may then be sent to a computer or other electronic analysis device, which uses known electronic/computer-vision techniques to determine the locations of the sensors. Position measurements of the sensors, or detection, may be made periodically, preferably at a rate fast enough to capture the essence of the fastest motions made. Typically, 30 Hz should be fast enough, although for some martial arts or sports, a faster detection rate may be needed. For contemplative activities such as yoga, rates as slow as 1 Hz or slower may be adequate.

The computer or other electronic analysis device may then compare the sensor position and motion information with data that was previously stored on the computer or electronic analysis device. The previously stored data may represent the movements or positions of an expert, and may define the conforming regions for the sensors, which in general may change with time to reflect movements, although they may also be fixed in time to reflect postures. For example, the previously stored data may represent the positions of particular acupuncture and/or chakra points of a yoga master in particular yoga poses. Or the previously stored data may represent the movements of particular acupuncture and/or chakra points of a tai chi master performing particular tai chi routines. Or the previously stored data may represent the movements of particular vital energy points of a student either during solitary practice, or during instruction from an expert.

The invention may be used to analyze and/or synthesize the motion or positions of vital energy points in a wide variety of physical activities. In one aspect, the invention may be used to analyze or synthesize motions performed in combat sports, including but not limited to, Aikido, boxing, fencing, Judo, Ju-jitsu, Karate, Sambo, Sumo, Tae kwon do, wrestling, and Wushu.

In another aspect, the invention may be used to analyze or synthesize motions performed in cycling sports, including but not limited to, BMX, cycloball, cyclocross, mountain bicycling, road cycling, and track cycling.

In another aspect, the invention may be used to analyze or synthesize motions performed in motorized sports, including but not limited to, autosport, motorboat racing, and motorcycle racing. In another aspect, the invention may be used to analyze or synthesize motions performed in extreme sports, including but not limited to, skateboarding, wakeboarding, bungee jumping, snowboarding, and inline skating.

In another aspect, the invention may be used to analyze or synthesize motions performed in gymnastics, including but not limited, to aerobics, acrobatics, artistic gymnastics, rhythmic gymnastics, and trampoline.

In another aspect, the invention may be used to analyze or synthesize motions performed in track and field athletics, including but not limited to, triple jump, high jump, long jump, sprinting, running, discus, hammer throw, javelin, shot-put, pole vaulting, and speed walking.

In another aspect, the invention may be used to analyze or synthesize motions performed in power sports, including but not limited to, bodybuilding, power lifting, tug of war, and weightlifting.

In another aspect, the invention may be used to analyze or synthesize motions performed in racket sports, including but not limited to, badminton, racquetball, royal tennis, soft tennis, squash, table tennis, and tennis.

In another aspect, the invention may be used to analyze or synthesize motions performed in skating, including but not limited to, figure skating, roller hockey, roller skating, short-track speed skating, speed skating, and synchronized skating.

In another aspect, the invention may be used to analyze or synthesize motions performed in skiing, including but not limited to, alpine skiing, back-country skiing, biathlon, cross country skiing, Firngleiten, freestyle skiing, grass skiing, Nordic combined, roller skiing, skibob, Skijoring, ski jumping, ski touring, snowboarding, speed skiing, telemark skiing.

In another aspect, the invention may be used to analyze or synthesize motions performed in sleighing, including but not limited to, bobsleigh, land luge, luge, and skeleton. In another aspect, the invention may be used to analyze or synthesize motions performed in target sports, including but not limited to, archery, billiards, Bocce, bowling, croquet, curling, darts, golf, disc golf, horseshoe throwing, laser tag, Petanque, and shooting.

In another aspect, the invention may be used to analyze or synthesize motions performed in team sports, including but not limited to, American football, Australian rules football, Bandy, baseball, Basque pelota, Camogie, Canadian football, cricket, curling, Faustball, floorball, football, Gaelic football, handball, hockey, hurling, ice hockey, Kabaddi, Korfball, Lacrosse, netball, paintball, polo, roller hockey, rugby, Sepak Takraw, Shinty, softball, volleyball, and ultimate Frisbee.

In another aspect, the invention may be used to analyze or synthesize motions performed in water sports, including but not limited to, canoeing, diving, dragon boat, kayaking, offshore powerboat racing, sculling, surf lifesaving, rowing, subaquatics, surfing, swimming, synchronized swimming, water polo, water skiing, wind surfing, sailing, and fishing.

In another aspect, the invention may be used to analyze or synthesize motions performed in animal sports in which the animal is lead or directed by a human subject, including but not limited to, equestrianism, Greyhound racing, pigeon sport, and camel racing. In this embodiment, the systems and methods may be applied to analyze either the animal's movements, or the human subject's movements, or both.

In another aspect, the invention may be used to analyze or synthesize motions performed in outdoor sports, including but not limited to, a erobatics, a eromodelling, ballooning, casting, flying disc, gliding, hang gliding, hiking, jogging, mountaineering, orienteering, parachuting, paragliding, skydiving, sled-dog sports, and sport fishing.

In another aspect, the invention may be used to analyze or synthesize motions performed in other activities, including but not limited to, ballet, ballroom dancing, BASE jumping, bungee jumping, dance sport, dance, disabled sports, foosball, modem pentathlon, Tantric yoga, and triathlon.

In another aspect, the invention may be used to analyze or synthesize motions performed in mind sports or strategy games, including but not limited to, bridge, chess, poker, Go, scrabble, and Shogi.

In another aspect, the invention may be used to analyze or synthesize motions performed in rehabilitation and physical therapy.

In another aspect, the invention may be used to analyze or synthesize motions performed in the hand-eye coordination or mind-body coordination movements intrinsic in education, or in language arts, or inherent in learning tools or in learning games, and/or in various reading arts, such as phonics or learning the ABC's.

In another aspect, the invention may be used to analyze or synthesize motions performed in household activities, including but not limited to, vacuuming, carpentry, and gardening.

In another aspect, the invention may be used to analyze or synthesize motions performed in work-out exercises, including but not limited to, stationary biking, treadmill running, stairstepping, rowing machines, Jazzercise, Pilates, Non-Impact Aerobics, jumping rope, kickboxing, and stretching exercises.

In another aspect, the invention may be used to analyze or synthesize motions performed in vision therapy and/or audiology.

In one embodiment, the invention includes a system for analyzing movement. When a subject assumes a posture or makes a movement, a computer, handheld device, or other device suitable for making comparisons between sets of data points, may compare the data representing the posture or movement with a prerecorded set of data representing the same posture or movement performed by an expert or otherwise prerecorded. For example, the prerecorded set of data may be programmed by an acupuncturist who is familiar with the optimal manner of moving acupuncture points in relation to one another to maximize energy benefits.

In one aspect, the invention may include an instantaneous feedback mechanism. The feedback mechanism may be audio, for example, a sound played through a speaker, and/or visual, for example, a graphical display on a television screen, computer or other electronic monitor, handheld device, or any other suitable display means, and/or tactile, for example, vibrations, pressure, or slight electric shocks. The instantaneous feedback mechanism provides feedback by indicating to the subject whether the subject's posture or movements are sufficiently close to the posture or movements indicated by the prerecorded set of data. If they are sufficiently close, the system may indicate this with positive feedback including soothing sounds, encouraging words, or other audio indicators, or visual indicators such as particular colors (for example, green), positive facial expressions (such as a smile) on a graphical representation of an expert or the subject, or any other predetermined graphical or visual indicator of a correct motion or posture or tactile indicator, such as a pleasing tingling vibration. If the subject's posture or movements are not sufficiently close to the posture or movements indicated by the prerecorded set of data, then the system may indicate this with negative feedback including alarm sounds, words indicating how to correct the posture or movement, or other audio indicators, or tactile indicators such as vibrations, or visual indicators such as colors (for example, red), negative facial expressions (such as a furrowed brow) on a graphical representation of an expert or the subject, arrows indicating the directions particular vital energy points should be moved to correct an errant posture or movement, or any other predetermined graphical or visual indicator of an errant motion or posture. If the subject's posture or movements are partially correct and partially wrong, the system can provide mixed feedback, preferably feedback that points out which part should be corrected.

In another aspect, the invention may include a user-selected background to enhance the entertainment value and encourage the use of the invention. The user may select a real background such as the pyramids, outer space, the Taj Mahal, a beach, underwater, or any other place that may be pleasing to the user. Alternatively, the background may be selected from among any fictional place the user may find pleasing such as an enchanted forest. In one embodiment, a user may provide a digital picture, which the system can then use as the background. Against this background, the system may provide a graphical representation of the subject that shows the subject's movements or posture as detected using any appropriate system, for example, the sensor systems described above. The system may also provide a graphical representation of an expert whose movements the subject should try to imitate as closely as possible. In one embodiment, the graphical representations of the subject and expert are overlaid in order to emphasize any disparity in the movements or postures between the subject and expert. In another embodiment, the graphical representations of the subject and expert are side by side.

In one embodiment, the invention includes a method of using the system described above to train in a novel movment tehcnique involving particular movements of particular energy points in order to benefit from an increase in energy. In this method, a plurality of energy points, including but not limited to, a cupuncture points, chakras, and reflexology points are assigned spherical regions definded by a radius extending outward a predetermined distance from the energy points. These spherical regions define boundaries within which the points may be moved. Two-dimensional slices of these spherical regions result in circular areas in which the energy points may be moved in various geometric patterns bounded by the ciruclar areas. For example, the energy point kidney 1 acupuncture point on the sole of the foot may be assigned a spherical region 10 cm above the ground with a radius of 5 cm. A horizontal slice of that sphere results in a circle parallel to the ground in which the kidney 1 point may be moved in various geometric patterns bounded by the circle, such as a triangle, square, pentagon, hexagon, figure eight (8), FIG. 8 on its side meaning the infinity symbol, or a yin-yang symbol, for example. The simpler movements such as circular movements are appropriate for beginners, while more advanced geometries, such as pentagons, for example, are appropriate for more advanced students.

The central idea behind this embodiment of a movement method for use with the present invention is that the meridians and energy points, while they are distinct, connect with each other and come together to form a whole single unit. Thus, when vital energies are flowing properly, certain movements in one part of the body naturally affect movements in another part of the body. The method allows direction of energy transfer throughout the entire body from the bottom of the feet through the top of the head and through the hands to the fingers and back again. The method sequentially connects each of the individual isolated energy points in the body in order to allow the entire body to work as a single connected unit, thus improving energy flow throughout the entire body.

For example, in a simple exercise that falls within the method of the invention, a subject lies down facing upwards and moves the right kidney 1 point (on the right foot) clockwise in a circular motion with a predetermined radius, as described above. When the energy paths are properly unobstructed such that energy is flowing freely, the left kidney 1 point (on the left foot) will naturally move in the same motion, only as a mirror-image, thus moving counterclockwise. Using the system of the invention, the motion of the sensors on the two kidney 1 points will allow the system to determine whether the subject is moving correctly, and thus will provide feedback and the opportunity for the subject to self-correct. The system may measure the clockwise motion of the right kidney 1 point to ensure consistent, steady, well-defined circular movement, and measure the motion of the left kidney 1 point to ensure it is moving counterclockwise at the same rate with the same radius as the right foot. If so, the system provides positive feedback; if not, the system provides negative feedback and the opportunity to correct.

In another aspect, the invention includes a method for analyzing breathing of a human subject by placing one or more sensors on one or more vital energy points throughout the human subject's body. The sensors may be placed in an extended manner along meridians, at the endpoints of meridians, on chakras, or they may be placed at any other vital energy point known to those skilled in the art of breathing techniques. The positions of the sensors are detected by any suitable detection means, including detections of signals sent by the sensor indicating their positions or video detection of the sensors followed by image analysis to determine the positions of the sensors, or by other position or motion capture technologies known to those skilled in that art.

The positions of the one or more sensors as detected are compared to a predetermined set of positions of one or more corresponding vital energy points. The predetermined set of positions of vital energy points can be made by an expert who has assumed the postures or made the movements that the subject is practicing, or preprogrammed by an expert who knows how the various vital energy points should be positioned or moved. A visual and/or auditory and/or tactile signal is provided to indicate whether the positions of the one or more sensors on the subject match the predetermined set of positions of one or more vital energy points. For example, in a simple inhale, sensors placed on Pericardium 6, the second chakra, Stomach 36, Spleen 6, and Conception Vessel 17 should move as one unit; on the exhale, the same movement, in reverse, should result.

It will be apparent to those skilled in the art that different physical activities should emphasize different vital energy points. One example may be to use the system and methods of the invention to analyze golf movements wherein sensors may be placed on the Kidney 1, Stomach 36, Large Intestine 10, and Du 20 acupuncture points. In another example, to use the system and methods of the invention to analyze baseball movements, sensors may be placed on the Kidney 1, Spleen 6, Stomach 36, and Large Intestine 4 and Large Intestine 11 acupuncture points. In another aspect, the system and methods of the invention may be used to analyze stretching movements, and sensors may be placed on the Gall Bladder 39, Spleen 9, Stomach 37, Stomach 35, Liver 13, Liver 14, Large Intestine 14, and Large Intestine 4 acupuncture points. Another example may be to use the system and methods of the invention to analyze breathing, wherein sensors may be placed on the Lung 1, Kidney Shu, Ren 4, and Ren 17 acupuncture points, and the Second and Fourth Chakras. In another aspect, to use the system and methods of the invention for vision therapy, sensors may be placed on the Large Intestine 1, Lung 11, and Liver 3 acupuncture points. In another aspect, to use the system and methods of the invention for audio-therapy/audiology, sensors may be placed on the Large Intestine 4, Stomach 36, San Jiao 1, Kidney 3, and Liver 3 acupuncture points. Another example may be to use the system and methods of the invention to analyze walking movements, wherein sensors may be placed on the Kidney 1 and Large Intestine 4 acupuncture points.

To use the system and methods of the invention to analyze movements for purposes of pain management and rehabilitation, the locations of the sensors should be placed optimally for the affected areas of the body. For example, for shoulder pain, sensors may be placed on the Lung 1, Gall Bladder 20, Small Intestine 10, Small Intestine 11, Small Intestine 12, Small Intestine 13, Large Intestine 5, and Lung 9 acupuncture points. For upper back pain, sensors placed on the Bladder 11, 12, 13 and 14 acupuncture points. For middle back pain, sensors may be placed on the Bladder 15, 16, 17, and 18 acupuncture points. For lower back pain, sensors may be placed on the Bladder 21, Bladder 22, Bladder 23, and Bladder 24, Bladder 25, Bladder 26, Bladder 27, Bladder 28 acupuncture points. For pelvic pain, sensors may be placed on the Sanjiao 5 and Gall Bladder 41 acupuncture points. For neck pain, sensors may be placed on the Du 14, Du 15, Du 16, Du 19, Du 20 and Gall Bladder 20 acupuncture points. The acupuncture points are listed here for example only. There are in principle as many combinations of acupuncture points for treatment of a condition as there are people who have the condition. The invention should not be construed to be limited to the acupuncture points mentioned herein by way of example.

In a more advanced embodiment of the method that may be used together with or independently of the embodiment in which sensors are placed on vital energy points, sensors may allow detection of more subtle movements by means of measuring weight shifts. For example, a subject may have both feet planted on the ground directly under the hips; without any detectable motions, the subject may shift weight from center to the right, thus applying more weight to the outside of the right foot and the inside of the left foot. As weight is shifted back to the left, more weight is applied to the inside of the right foot and the outside of the left foot. These weight shifts can be detectable by means of weight sensors placed on vital energy points on the soles of the feet and the toes. In reclined positions, weight shifts can be detectable by means of weight sensors placed on vital energy points in contact with the floor. The shifting of weight in a controlled manner through the vital energy points can increase the vital energy flow throughout the body. The system of the invention provides a valuable feedback mechanism to inform a student of the method when the subject's shifting weight results in proper energy flow through the vital energy points.

In one embodiment, the invention includes one or more devices for providing tactile feedback. This embodiment of the invention may be used independently of or in conjunction with the various other aspects of the invention, as described above. In this aspect, the sensors and tactile feedback devices may be placed on vital energy points, although they need not necessarily be placed on vital energy points. The tactile feedback devices may comprise vibrators for providing vibrations as the tactile feedback, pressure generators for providing pressure as the tactile feedback, or electricity generators, for providing slight electrical shocks as the tactile feedback. The devices for providing tactile feedback may be part of the sensors, or they may be separate devices. In a preferred embodiment, the devices for providing tactile feedback are associated with sensors and each one is located near a sensor.

In this embodiment, when the system of the invention detects an errant movement, it may provide specific and instantaneous tactile feedback. For example, if sensors are placed on a subject's wrists, corresponding tactile feedback devices may be placed on the subject's forearm very near the sensors. Sensors comprise the tactile feedback devices such that when the sensors are placed on the subject's wrists, the tactile feedback devices are likewise on the subject's wrists. The subject then uses the system to follow the subject's movements, which should conform to movements specified by a prerecorded set of data. If the subject's right arm moves outside of the conforming region, which the system recognizes as being the area in which the subject's right arm should be in order to match the prerecorded set of data, then the system will provide feedback in the form of any type of tactile sensation from the device on or near the subject's right wrist. If the subject's left arm conforms to the movements dictated by the prerecorded set of data, however, not actile feedback or a different sort of tactile feedback is provided to the device on or near the subject's left wrist. In this embodiment, the prerecorded set of data can be created by reference to the positions and movements of vital energy points, or it may be created by reference to arbitrary points on the body.

Preferably, this embodiment includes devices that can provide a range of tactile feedback depending on how far out of the conforming region the corresponding sensors move. For example, if the tactile feedback device is a vibrator, it may provide small amplitude vibrations if its corresponding sensor is close to the conforming region, and larger amplitude vibrations the farther the corresponding sensor moves from the conforming region. If the tactile feedback device delivers pressure, for example by having a strap-on device that shrinks or constricts, then the amount of pressure may increase the farther the corresponding sensor moves from the conforming region. If the tactile feedback device delivers electrical stimulation, then the magnitude of that stimulation would likewise increase the farther the corresponding sensor moves from the conforming region. Preferably, an upper limit on the magnitude of any tactile feedback should be established for safety purposes.

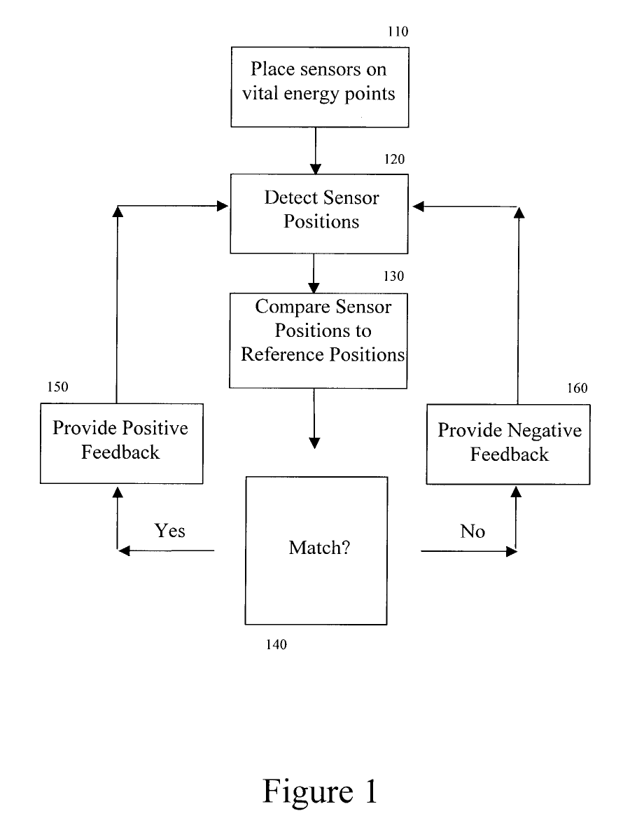

FIG. 1 is a flow chart showing an embodiment of the method of the invention. Sensors are placed on various vital energy positions on a user's body in step 110. The vital energy positions may vary according to what activity the user will be performing, or what aliment the user wants to treat. While the user is performing an activity, the positions of the sensors are periodically detected 120. The detected positions of the sensors are then compared to a set of reference positions 130. Preferably, an expert skilled in the correct alignment and movement of energy through the vital energy points in the human body has prerecorded the reference positions. A determination is then made 140 as to whether the detected positions match the reference positions to within some predetermined tolerance level. If the detected positions match the reference positions, then positive feedback is provided to the user 150. If the detected positions do not match the reference positions, then negative feedback is provided to the user 160. Shortly thereafter, or during the step of providing feedback, another sensor position detection event 120 occurs, and the cycle begins again.

### EXAMPLE 1

It has been found that walking on the kidney 1 acupuncture points on the feet can increase a walker's energy level. Thus, one system of the invention includes sensors to be placed on the soles of a walker's feet on the kidney 1 acupuncture points, a receiver for receiving signals from the sensors when the walker correctly walks on the kidney 1 acupuncture points, and headphones or other electronic device for providing positive and negative feedback so that the walker can appreciate walking correctly or correct incorrect walking. Thus, sensors are placed on the kidney 1 acupuncture points on the soles of a walker's feet. When the walker's foot falls correctly on the kidney 1 point, thus providing the beneficial increase in the walker's energy level, the sensor sends a signal to a receiver. The receiver interprets the signal as correct walking, and a pleasing sound is provided through the headphones or other electronic device, which the walker understands to be positive feedback for correct walking. When the foot does not fall correctly on the kidney 1 point, the sensor may send no signal or a different signal, distinct from the correct walking signal. The receiver detects either no signal or the different signal, and either no sound is played on the headphones or other display device, or a sound is played that the walker appreciates as being negative feedback to advise the walker to correct the walker's walking style.

### EXAMPLE 2

Sensors are placed on a subject's body at known acupuncture points Kidney 1, Kidney 3, Spleen 6, Spleen 9, Spleen 10, Stomach 36, San Jiao 5, Pericardium 6, Pericardium 8, Large Intestine 10, Large Intestine 11, Gall Bladder 20, Gall Bladder 34, and Bladder 10. The subject performs tai chi in front of a video or other electronic screen. The positions of the sensors are tracked and recorded periodically at 30 Hz. The positions of the sensors are transmitted to a computer or other electronic analysis device each time the sensor positions are determined. The computer or other electronic analysis device records the positions of the sensors. The positions of the sensors indicate “posture” data. The computer or other electronic analysis device compares the positions of the sensors to previously recorded positions of the sensors thus generating “movement” data. The computer or other electronic analysis device compares the posture data and the movement data to prerecorded sets of posture data and movement data generated by an experienced tai chi master.

The computer or other electronic analysis device displays a graphical representation of the subject on a video screen. The movements of the graphical representation of the subject track the movements of the subject as indicated by the positions of the sensors. The graphical representation of the subject is depicted in Giza with the Great Pyramid in the background. If the posture data does not match the prerecorded set of posture data within a predetermined tolerance limit, the computer or other electronic analysis device generates a signal. The signal consists of red lights indicating the positions of the sensors that are out of place on the graphical representation of the subject and arrows indicating the directions that the subject should move in order to bring the sensors into the correct positions. The signal is accompanied by an audio signal, alerting the subject that the vital energy points are not in correct alignment. If the movement data does not match the prerecorded set of movement data within a predetermined tolerance limit, the computer or other electronic device generates a signal. The predetermined tolerance limit may be adjusted by the user within a range from beginner through intermediate to advanced. In the beginner mode, the tolerance limit is greater, whereas in the advanced mode, the tolerance level is less, thus requiring more accurate movements to stay within the tolerance level. The signal indicates the positions of the sensors that are not being moved correctly on the graphical representation of the subject by displaying arrows that point in the direction the movement should be made. The arrows are green if the movement should be made faster than it is currently being made, and the arrows are red if the movement should be made more slowly.

When a set of movements is complete, the subject views a recording of the set of movements as a replay of the graphical representation of the subject's movements, including any indicators of errant movements or positions. The subject can store the representation on a local storage device such as a hard disk, may save it on a remote storage device over or within a communications network, or may print the representation out on a printer. The graphical representation of the subject is overlaid with a graphical representation of the prerecorded sets of posture data and movement data generated by an experienced tai chi master so that the subject can compare the subject's movements with those of the master in order to improve the subject's performance.

### EXAMPLE 3

Sensors comprised of a sensing unit and a vibrating unit are placed on a subject's wrists, elbows, shoulders, ankles, knees, and hips. The positions of the sensors are tracked and recorded periodically at 30 Hz. The positions of the sensors are transmitted to a computer or other electronic analysis device each time the sensor positions are determined. The computer or other electronic analysis device records the positions of the sensors. The positions of the sensors indicate “posture” data. The computer or other electronic analysis device compares the positions of the sensors to previously recorded positions of the sensors thus generating “movement” data. The computer or other electronic analysis device compares the posture data and the movement data to prerecorded sets of posture data and movement data generated by an experienced tai chi master.

The subject watches the prerecorded movements of a tai chi master on a video display, and attempts to mimic the master's movements. In attempting to mimic a particular sweeping arm movement, the subject's right wrist falls below the correct height. The computer or other electronic analysis device compares the position of the sensor on the subject's right wrist to the prerecorded data indicating the correct position of the right wrist during that particular movement. The comparison indicates that the subject's right wrist is too low, and thus outside of the conforming region. The computer or other electronic analysis device sends a signal to the sensor on the subject's right wrist, which then begins to vibrate gently.

The vibration on the subject's right wrist indicates to the subject that the right wrist is outside of the conforming region, and thus not correctly aligned. The subject lowers the right wrist farther, thus bringing the right wrist even farther from the conforming region, and further out of alignment with the correct position. The computer or other electronic analysis device compares the position of the sensor on the subject's right wrist to the prerecorded data indicating the correct position of the right wrist. The comparison indicates that the subject's wrist is even farther out of alignment than before. The computer or other electronic analysis device sends a signal to the sensor on the subject's right wrist, which then vibrates more intensely than before.

The more intense vibration on the subject's right wrist indicates to the subject that the right wrist is even farther from the conforming region than before, thus indicating that the subject moved the right wrist in the wrong direction. The subject thus raises the right wrist to bring it back into the conforming region. The computer or other electronic analysis device compares the position of the sensor on the subject's right wrist to the prerecorded data indicating the correct position of the right wrist. The comparison indicates that the subject's wrist is now in correct alignment with the position indicated by the prerecorded data. The computer or other electronic analysis device sends a signal to the sensor on the subject's right wrist, which then ceases vibrating. The subject now knows that the right wrist is in the correct position.

While the invention has been described in combination with embodiments thereof, many alternatives, modifications, and variations will be apparent to those skilled in the art in light of the foregoing description. Accordingly, the invention is intended to embrace all such alternatives, modifications, and variations as fall within the spirit and broad scope of the appended claims. All patent applications, patents, and other publications cited herein are incorporated by reference for all purposes in their entirety.

What is claimed is:

1. A method for analyzing postures or movements of a human subject, comprising the steps of:
placing one or more sensors on one or more vital energy points throughout the human subject's body,
detecting the positions of the one or more sensors,
comparing the positions of the one or more sensors to a predetermined set of positions of one or more corresponding vital energy points,
determining whether the positions of the one or more sensors match the predetermined set of positions of the one or more corresponding vital energy points, and
providing a visual, auditory, or tactile signal to indicate whether the positions of the one or more sensors match the predetermined set of positions of the one or more corresponding vital energy points.

2. The method of claim 1, wherein the vital energy points are chakras.

3. The method of claim 1, wherein the vital energy points are acupuncture points.

4. The method of claim 1, wherein the method is used to analyze yoga postures.

5. The method of claim 1, wherein the method is used to analyze martial arts movements.

6. The method of claim 1, wherein the method is used to analyze tai chi/chi gong movements.

7. The method of claim 1, wherein the sensors are extended along meridians.

8. The method of claim 1, wherein the sensors are placed at the endpoints of meridians.

9. The method of claim 1, further comprising displaying a graphical representation of the human subject, wherein the graphical representation of the human subject moves in the same way as the human subject moves.

10. The method of claim 9, wherein the graphical representation of the human subject is depicted in an environment selected by the human subject.

11. The method of claim 9, further comprising a graphical representation of a reference body, wherein the graphical representation of the reference body depicts the predetermined set of positions of vital energy points.

12. A system for analyzing postures or movements of a human subject, comprising:
one or more sensors placed on one or more corresponding vital energy points throughout the human subject's body,
a detector, wherein the detector detects the positions of the one or more sensors,
a computer or other electronic analysis device, wherein the computer or other electronic analysis device receives data from the detector, the data indicating the positions of the one or more sensors, and the computer or other electronic analysis device compares the positions of the one or more sensors with a predetermined reference set of positions of the one or more corresponding vital energy points to determine whether the positions of the one or more sensors match the predetermined set of positions of the one or more corresponding vital energy points, and
a device for providing feedback, wherein the device for providing feedback provides a visual signal, an auditory signal, or a tactile signal to indicate whether the positions of the one or more sensors match the predetermined set of positions of the corresponding one or more vital energy points.

13. The system of claim 12, wherein the vital energy points are chakras.

14. The system of claim 12, wherein the vital energy points are acupuncture points.

15. The system of claim 12, wherein the system is used to analyze all systems of yoga.

16. The system of claim 12, wherein the system is used to analyze all systems of martial arts movements.

17. The system of claim 12, wherein the system is used to analyze all systems of tai chi/chi gong movements.

18. The system of claim 12, wherein the system is used to analyze all systems of movements in combat sports.

19. The system of claim 12, wherein the system is used to analyze all systems of movements in cycling.

20. The system of claim 12, wherein the system is used to analyze all systems of movements in motorized sports.

21. The system of claim 12, wherein the system is used to analyze all systems of movements in extreme sports.

22. The system of claim 12, wherein the system is used to analyze all systems of movements in gymnastics.

23. The system of claim 12, wherein the system is used to analyze all systems of movements in track and field athletics.

24. The system of claim 12, wherein the system is used to analyze all systems of movements in power sports.

25. The system of claim 12, wherein the system is used to analyze all systems of movements in racket sports.

26. The system of claim 12, wherein the system is used to analyze all systems of movements in skating.

27. The system of claim 12, wherein the system is used to analyze all systems of movements in skiing.

28. The system of claim 12, wherein the system is used to analyze all systems of movements in sleighing.

29. The system of claim 12, wherein the system is used to analyze all systems of movements in target sports.

30. The system of claim 12, wherein the system is used to analyze all systems of movements in team sports.

31. The system of claim 12, wherein the system is used to analyze all systems of movements in water sports.

32. The system of claim 12, wherein the system is used to analyze all systems of movements in animal sports.

33. The system of claim 12, wherein the system is used to analyze all systems of movements in outdoor sports.

34. The system of claim 12, wherein the system is used to analyze all systems of movements in mind sports or strategy games.

35. The system of claim 12, wherein the system is used to analyze all systems of movements in rehabilitation or physical therapy.

36. The system of claim 12, wherein the system is used to analyze all systems of movements in household activities.

37. The system of claim 12, wherein the system is used to analyze all systems of movements in workout exercises.

38. The system of claim 12, wherein the system is used to analyze all systems of movements in vision therapy and audiology.

39. The system of claim 12, wherein the sensors are extended along meridians.

40. The system of claim 12, wherein the sensors are placed at the endpoints of meridians.

41. The system of claim 12, wherein the computer or other electronic analysis device displays a graphical representation of the human subject, and the graphical representation of the human subject moves in the same way as the human subject moves.

42. The system of claim 41, wherein the graphical representation of the human subject is depicted in an environment selected by the human subject.

43. The system of claim 41, further comprising a graphical representation of a reference body, wherein the graphical representation of the reference body depicts the predetermined set of positions of vital energy points.

44. A system for analyzing postures or movements of a human subject, comprising:
means for determining the positions of vital energy points throughout the human subject's body,
means for comparing the positions of vital energy points throughout the human subject's body to a predetermined reference set of positions of vital energy points to determine whether the positions of the sensors match the predetermined set of positions of vital energy points, and
means for indicating whether the positions of the sensors match the predetermined set of positions of vital energy points.

45. The system of claim 44, wherein the vital energy points are acupuncture points.

46. The system of claim 44, wherein the vital energy points are chakras.

47. The system of claim 44, wherein the vital energy points are along meridians.

48. The system of claim 44, further comprising a means for displaying a graphical representation of the human subject wherein the graphical representation of the human subject moves in the same way as the human subject moves.

49. The system of claim 48, wherein the graphical representation of the human subject is depicted in an environment selected by the human subject.

50. The system of claim 48, further comprising a graphical representation of a reference body, wherein the graphical representation of the reference body depicts the predetermined set of positions of vital energy points.

51. A system for analyzing postures or movements of a human subject, comprising:
one or more sensors placed on one or more points throughout the human subject's body,
one or more tactile feedback devices corresponding to said one or more sensors,
a detector, wherein the detector detects the positions of the one or more sensors,
a computer or other electronic analysis device,
wherein the computer or other electronic analysis device receives data from the detector, the data indicating the positions of the one or more sensors, and the computer or other electronic analysis device compares the positions of the one or more sensors with a predetermined reference set of positions to determine whether the positions of the one or more sensors match the predetermined set of positions, and wherein when the positions of at least one of the one or more sensors does not match the predetermined set of positions, then at least one of the tactile feedback devices is activated.

52. The system of claim 51, wherein the sensors comprise the tactile feedback devices.

53. The system of claim 51, wherein the tactile feedback devices send stronger signals when the corresponding sensors are farther from the predetermined set of positions.

54. The system of claim 52, wherein the tactile feedback devices send stronger signals when the corresponding sensors are farther from the predetermined set of positions.

55. The system of claim 51, wherein the tactile feedback devices are vibrators.

56. The system of claim 51, wherein the tactile feedback devices generate electric shocks.

57. The system of claim 51, wherein the tactile feedback devices generate pressure.

58. The system of claim 52, wherein the tactile feedback devices are vibrators.

59. The system of claim 52, wherein the tactile feedback devices generate electric shocks.

60. The system of claim 52, wherein the tactile feedback devices generate pressure.

61. The system of claim 53, wherein the tactile feedback devices are vibrators.

62. The system of claim 53, wherein the tactile feedback devices generate electric shocks.

63. The system of claim 53, wherein the tactile feedback devices generate pressure.

64. The system of claim 54, wherein the tactile feedback devices are vibrators.

65. The system of claim 54, wherein the tactile feedback devices generate electric shocks.

66. The system of claim 54, wherein the tactile feedback devices generate pressure.

67. The system of claim 51, wherein the sensors are placed on vital energy points.

68. The system of claim 52, wherein the sensors are placed on vital energy points.

69. The system of claim 12, wherein the system is used to analyze all systems of movements in breathing.

70. The system of claim 12, wherein the system is used to analyze movements associated with the training and teaching of body, hand, mind, and vital energy coordination as applied to the educational and language arts.

71. The system of claim 12, wherein the system is used to analyze movements in rehabilitation, pain management, or physical therapy.

72. The system of claim 12, wherein the system is used to analyze movements in healthcare practices selected from massage therapy, chiropractic body coordination, and body coordination for proper osteopathic manipulation.

73. The system of claim 12, wherein the system is used to analyze movements in the martial arts selected from wing chun, praying mantis, black cat, white eyebrow, hung gar, choy foot, wushu, shaolin, kempo, jeet kune do, karate, Tae kwan do, taichi, hsing-I, bagua, hapkido, and capoeira.
